(19) United States
(12) Patent Application Publication
(10) Pub. No.: US 2015/0135066 A1
(43) Pub. Date: May 14, 2015

(54) DUAL TEXT AND DRAWING INPUT

(71) Applicant: Lenovo (Singapore) Pte. Ltd., Singapore (SG)

(72) Inventors: Xin Feng, Arcadia, CA (US); Mei-Wen Sun, Raleigh, NC (US); James Anthony Hunt, Chapel Hill, NC (US); Heng Zheng, Beijing (CN)

(73) Assignee: Lenovo (Singapore) Pte. Ltd., Singapore (SG)

(21) Appl. No.: 14/076,494

(22) Filed: Nov. 11, 2013

(51) Int. Cl. G06F 17/21; G06F 3/0488

(52) U.S. Cl. CPC G06F 17/214; G06F 3/04883
USPC 715/268

(57) ABSTRACT

An embodiment provides a method, including: receiving handwriting input at a user input interface; rendering the handwriting input on a display device; after rendering the handwriting input, determining a user selection of a format for entering the handwriting input into an application; and entering the handwriting input into the application in the format selected. Other aspects are described and claimed.

### BACKGROUND

Information handling devices (“devices”), for example laptop computers, tablets, smart phones, e-readers, etc., may be used to accept user inputs in various formats. Among the formats of user inputs currently utilized are drawing inputs and handwriting inputs. Often such inputs are provided for by a user input component such as a touch screen (for direct input) or digitizer (for indirect or separate input from a display) that accepts the inputs, e.g., as provided by a writing implement such as a pen or stylus or even finger input. Various user input components require the writing or drawing implement to actually touch the component, while other user input components may not require actual contact.

In conventional user input interfaces, a user input, e.g., a drawing input, is accepted via the input component (e.g., touch screen) and input to an application, e.g., a drawing application. Depending on the underlying application, the user input provided, e.g., handwriting input, may translated into another format, e.g., machine text for input into the underlying application. For example, a user may provide handwriting input that is converted to machine text for entry into an email application, a word processing application, an Internet search application or web browser, etc.

### BRIEF SUMMARY

In summary, one aspect provides a method, comprising: receiving handwriting input at a user input interface; rendering the handwriting input on a display device; after rendering the handwriting input, determining a user selection of a format for entering the handwriting input into an application; and entering the handwriting input into the application in the format selected.

Another aspect provides an information handling device, comprising: an user input interface; a display device; a processor; and a memory device storing instructions executable by the processor to: receiving handwriting input at the user input interface; rendering the handwriting input on the display device; after rendering the handwriting input, determining a user selection of a format for entering the handwriting input into an application; and entering the handwriting input into the application in the format selected.

A further aspect provides a program product, comprising: a storage medium comprising computer readable program code, the computer readable program code comprising: computer readable program code configured to receive handwriting input at a user input interface; computer readable program code configured to render the handwriting input on a display device; computer readable program code configured to, after rendering the handwriting input, determine a user selection of a format for entering the handwriting input into an application; and computer readable program code configured to enter the handwriting input into the application in the format selected.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of an information handling device.

FIG. 3(A-B) illustrates a user input interface for dual input of text and drawing.

FIG. 4 illustrates an example method of providing text and drawing input to a dual user input interface.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

Handwriting software is increasingly popular, particularly with devices that include a touch screen devices such as smart phones, tablets and devices coupled to a touch screen display. Conventional handwriting software is primarily focused on converting the handwriting input provide by the user into text input. If user wants to input the handwriting in unaltered form, e.g., as a drawing such as a signature or an actual drawing, etc.), the user needs plan ahead for this and switch to a different mode (e.g., a drawing mode) prior to providing the input, or to utilize different software altogether. There is no easy way for a user to conveniently switch between having an application convert the input (for text input) and not convert the input (for drawing input). In other words, conventional user input interfaces do not support “dual mode” inputs.

For example, in the PENPOWER handwriting application, a user must switch to a different mode called “signature mode” to thereafter input drawing. If user wants to input text, then the user must switch to “handwriting mode” prior to inputting handwriting. As is apparent, this is not convenient for the user as it requires switching back and forth between these two modes.

Accordingly, an embodiment provides a user input interface that supports dual mode inputs. Thus, using a dual mode user input interface, a user may seamlessly switch between formats (e.g., handwriting and drawing) for inputting unaltered or converted inputs to an application.

The illustrated example embodiments will be best understood by reference to the figures. The following description is intended only by way of example, and simply illustrates certain example embodiments.

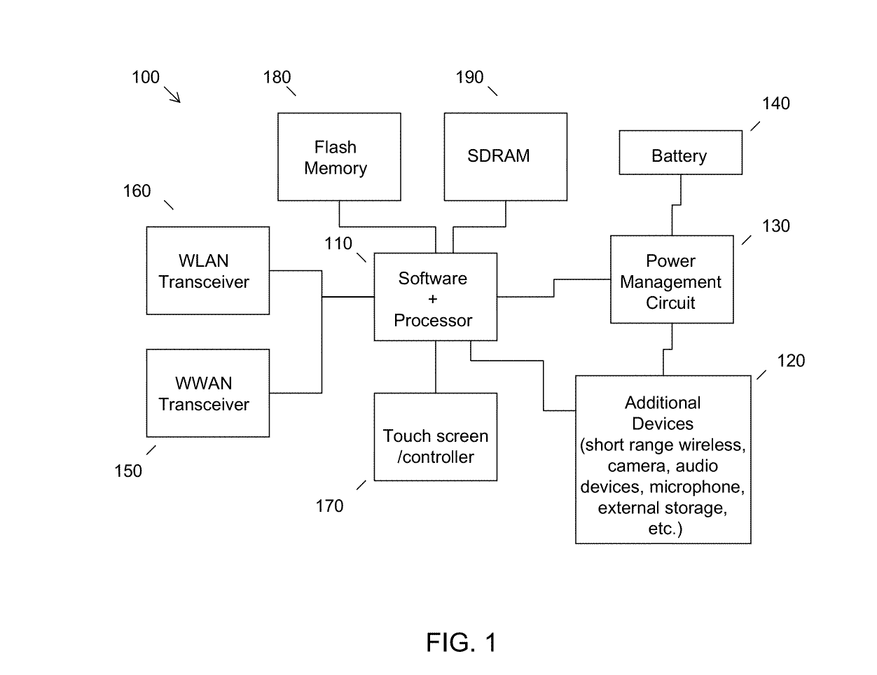

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces for example include SDIO and I2C.

There are power management chip(s) 130, e.g., a battery management unit, BMU, which manage power as supplied for example via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additionally, one of the additional devices 120 is commonly a short range wireless communication device, such as a BLUETOOTH radio. Commonly, system 100 will include a touch screen 170 for data input and display, e.g., for accepting handwriting and drawing inputs. System 100 also typically includes various memory devices, for example flash memory 180 and SDRAM 190.

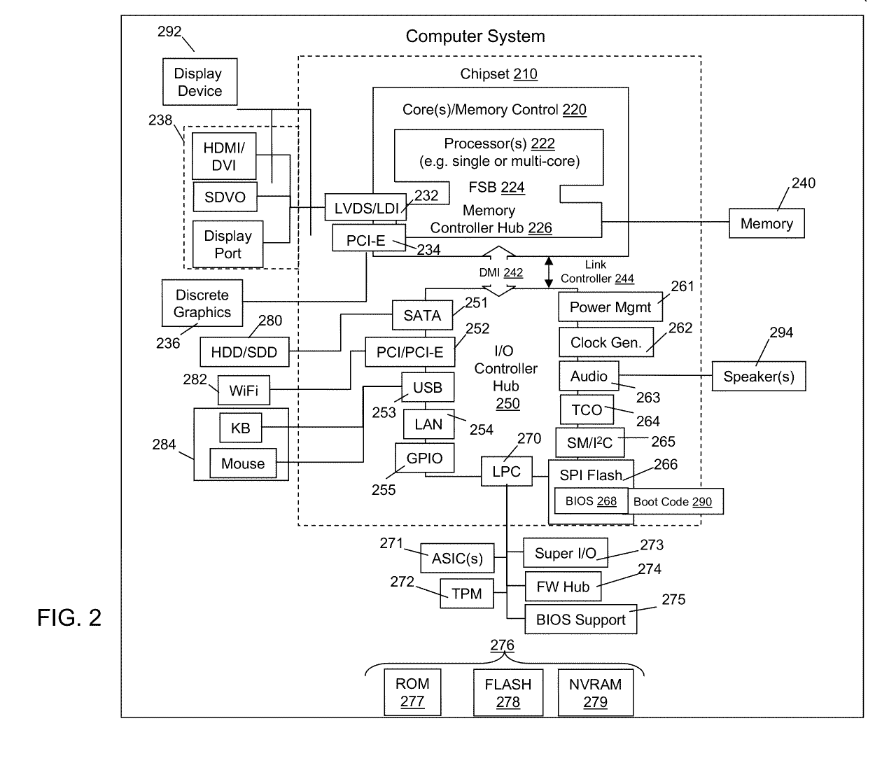

FIG. 2, for its part, depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). The architecture of the chipset 210 includes a core and memory control group 220 and an I/O controller hub 250 that exchanges information (for example, data, signals, commands, et cetera) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, et cetera). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, 280 et cetera), a PCI-E interface 252 (for example, for wireless connections 282), a USB interface 253 (for example, for devices 284 such as a digitizer, keyboard, mice, cameras, phones, microphones, storage, other connected devices, et cetera), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be used in devices that run applications that accept handwriting inputs. For example, devices may accept pen or stylus or finger input in the form of handwriting inputs. These handwriting inputs may be entered into an application in unaltered or unconverted format. For example, an email application may accept handwriting inputs and enter these into an email message body as an unaltered or unconverted signature or other drawing. Likewise, the application may accept handwriting inputs and alter or convert them, e.g., into machine text. Thus, a user may provide handwriting inputs that are analyzed and matched to letters for conversion into a predetermined machine font, which are then entered into the body of, e.g., an email message or like underlying application document.

Considering that both formats (herein “drawing format” for unaltered or unconverted format and “text format” for altered or converted format) may be appropriate for entry into the same application, an embodiment provides a dual format user input interface.

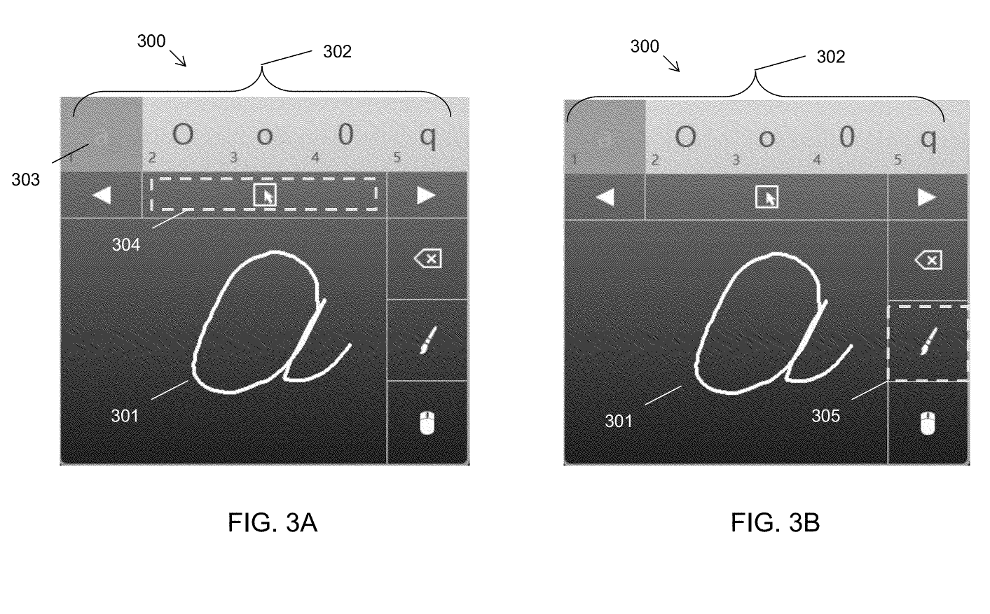

Referring to FIG. 3(A-B), an example dual mode user input interface 300 is illustrated. In FIG. 3A, the dual mode user input interface 300, e.g., as provided by a touch screen or other suitable component, renders user handwriting input 301, herein the form of a handwritten or scripted letter “a”. It should be noted that the handwriting input may be of a variety of forms, including but not limited to drawings, character(s) of a character based language, etc.

In an embodiment, the handwriting input 301 is analyzed, e.g., similar to optical character recognition, such that a preview panel or sub-area 302 may present or render text-input previews of the analyzed handwriting input 301. In the example illustrated, the top 5 previews are provided in the panel or sub-area 302, where an embodiment has determined with varying degrees of confidence that the handwriting input corresponds to “a”, “O”, “o”, “0” and “q”. The highest confidence match, in this example “a”, may be presented in an organized list in the preview panel or sub-area 302, here organized left to right in order of confidence and numbered 1-5.

Thus, a user is apprised of what the handwriting input 301 has been interpreted as via the panel or sub-area 302 such that, if the user thereafter decides this handwriting input should be entered as text, the text input result is known. Moreover, a user may select among the text previews of panel 302, e.g., if the highest ranked text preview, in this example “a” is incorrect.

If the user wishes to input text rather than the unaltered handwriting input 301, the user may select (or accept, if the proper selection is made) a text preview, e.g., 303, from the panel or sub-area 302. Thereafter, the user selects the format for which the input is to be rendered or input, e.g., to an underlying application. Thus, if a user determines that text input should be provided, a user may select the text format option 304 in the dual mode user input interface 300. The text input selected, here “a”, will therefore be confirmed and provided as input, e.g., to an underlying application.

In contract, if a user desires to input the unaltered or unconverted form of the input 301, referring to FIG. 3B, a user may instead select the drawing format option 305 instead of the text format option 303. Thus, the input 301 will be provided as the confirmed user input, e.g., to an underlying application. Therefore, the user, after providing input 301 will be able to select whether this input 301 is to be entered without conversion or alteration, e.g., as a signature or a drawing, or if it is to be converted or altered, e.g., to machine text.

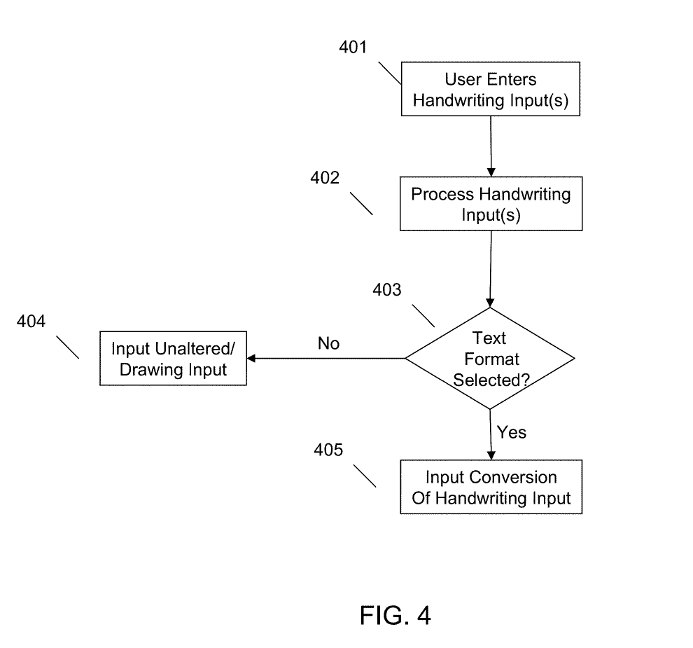

FIG. 4 outlines an example method for providing inputs using a dual mode user input interface according to an embodiment. As illustrated, a user provides handwriting input at 401. This handwriting input may then be analyzed by an embodiment, e.g., to determine if it matches a known input for conversion, e.g., a letter of the alphabet, a character of a character based language, a number, a predetermined symbol having underlying meaning (and associated functionality), etc. If the user then selects the text format, as determined at 403, the user input may thus be converted, e.g., into the letter, number, or as an indication that the function connected with a predetermined symbol should be executed at 405. Otherwise, a user may select that the input is to be provided, e.g., to an underlying application such as a word processing or email application, in an unaltered form at 404, for example for entry of a signature at the end of a message or document.

Therefore, using a user input interface that supports dual mode input, as provided by an embodiment, a user may conveniently determine if the inputs are to be rendered and provided, e.g., to an underlying application, in an unaltered or unconverted form or in an altered or converted form. This permits the user to continue providing handwriting inputs without the need to plan ahead as to which format of input is desired. Thus, a user may seamlessly transition between input modes even after inputs have been provided.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Aspects are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device or information handling device to produce a machine, such that the instructions, which execute via a processor of the device implement the functions/acts specified.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
receiving handwriting input at a user input interface;
rendering the handwriting input on a display device;
after rendering the handwriting input, determining a user selection of a format for entering the handwriting input into an application; and
entering the handwriting input into the application in the format selected.

2. The method of claim 1, wherein the format is selected from a group of formats consisting of a drawing format and a text format.

3. The method of claim 2, further comprising presenting sub-areas in the user input interface for selecting the drawing format and the text format.

4. The method of claim 2, further comprising presenting a text-input preview sub-area in the user input interface.

5. The method of claim 4, wherein the text-input preview sub-area in the user input interface displays the top n text inputs determined for the handwriting inputs, wherein n is an integer.

6. The method of claim 1, wherein the application is selected from the group of applications consisting of a word processing application, an email application, a slide presentation application, and a note taking application.

7. The method of claim 2, further comprising saving the text format of the handwriting input as metadata when the drawing format is selected.

8. The method of claim 2, further comprising saving biometric metadata of the drawing input when the drawing format is selected.

9. The method of claim 8, wherein the biometric metadata is selected from the group of data consisting of timestamp data, pressure data, position data, speed data, and curvature data.

10. The method of claim 1, wherein the user input interface and the display device are co-located in a touch screen.

11. An information handling device, comprising:
an user input interface;
a display device;
a processor; and
a memory device storing instructions executable by the processor to:
receiving handwriting input at the user input interface;
rendering the handwriting input on the display device;
after rendering the handwriting input, determining a user selection of a format for entering the handwriting input into an application; and
entering the handwriting input into the application in the format selected.

12. The information handling device of claim 11, wherein the format is selected from a group of formats consisting of a drawing format and a text format.

13. The information handling device of claim 12, wherein the instructions are further executable by the processor to present sub-areas in the user input interface for selecting the drawing format and the text format.

14. The information handling device of claim 12, wherein the instructions are further executable by the processor to present a text-input preview sub-area in the user input interface.

15. The information handling device of claim 14, wherein the text-input preview sub-area in the user input interface displays the top n text inputs determined for the handwriting inputs, wherein n is an integer.

16. The information handling device of claim 11, wherein the application is selected from the group of applications consisting of a word processing application, an email application, a slide presentation application, and a note taking application.

17. The information handling device of claim 12, wherein the instructions are further executable by the processor to save the text format of the handwriting input as metadata when the drawing format is selected.

18. The information handling device of claim 12, wherein the instructions are further executable by the processor to save biometric metadata of the drawing input when the drawing format is selected.

19. The information handling device of claim 18, wherein the biometric metadata is selected from the group of data consisting of timestamp data, pressure data, position data, speed data, and curvature data.

20. A program product, comprising:
a storage medium comprising computer readable program code, the computer readable program code comprising:
computer readable program code configured to receive handwriting input at a user input interface;
computer readable program code configured to render the handwriting input on a display device;
computer readable program code configured to, after rendering the handwriting input, determine a user selection of a format for entering the handwriting input into an application; and
computer readable program code configured to enter the handwriting input into the application in the format selected.
